(19) United States
(12) Patent Application Publication
(10) Pub. No.: US 2005/0063704 A1
(43) Pub. Date: Mar. 24, 2005

(54) Wavelength division multiplexing optical transmitter using wideband gain laser

(76) Inventors: Eun-Hwa Lee, Suwon-si (KR); Dong-Jae Shin, Suwon-si (KR); Jung-Kee Lee, Suwon-si (KR); Dae-Kwang Jung, Suwon-si (KR); Jun-Youn Kim, Suwon-si (KR)

Correspondence Address: CHA & REITER, LLC, 210 ROUTE 4 EAST STE 103, PARAMUS, NJ, 07652, US

(21) Appl. No.: 10/890,477

(22) Filed: Jul. 13, 2004

(30) Foreign Application Priority Data
Sep. 18, 2003 (KR) 2003-64875

(51) Int. Cl. H04J 14/00

(52) U.S. Cl. 398/66

(57) ABSTRACT

A WDM optical transmitter using a wideband gain laser comprises a plurality of wideband gain lasers and a wavelength division multiplexer. Each wideband gain laser includes a gain medium with a 3 dB bandwidth of 40 nm or more at a threshold current, and it amplifies corresponding incoherent light injected into the gain medium and outputs a corresponding channel. The multiplexer multiplexes channels, outputted from the wideband gain lasers, into an optical signal in a WDM scheme and outputs the multiplexed optical signal.

### CLAIM OF PRIORITY

This application claims priority to an application entitled “WAVELENGTH DIVISION MULTIPLEXING OPTICAL TRANSMITTER USING WIDEBAND GAIN LASER,” filed in the Korean Intellectual Property Office on Sep. 18, 2003 and assigned Serial No. 2003-64875, the contents of which are hereby incorporated by reference.

### BACKGROUND OF THE INVENTION

1. Field of the Invention

The present invention relates to a WDM (Wavelength Division Multiplexing) optical transmission system, and more particularly to a WDM optical transmitter utilized in the transmission system.

2. Description of the Related Art

Many optical elements, such as a distributed feedback (DFB) laser array, a multi-frequency laser (MFL), a spectrum-sliced light source, a mode-locked Fabry-Perot (FP) laser with incoherent light, and a reflective semiconductor optical amplifier (R-SOA), have been proposed as a means for a WDM light source. A spectrum-sliced light source is capable of providing a number of wavelength-divided channels by spectrum-slicing a broadband optical signal through an optical filter or a waveguide grating router (WGR). It is thus not required for the spectrum-sliced light source to employ a light source of a specific lasing wavelength as well as an equipment for wavelength stabilization. A light emitting diode (LED), a superluminescent diode (SLD), a Fabry-Perot laser, a fiber amplifier light source, and an ultra short pulse light source have been proposed as such a spectrum-sliced light source.

The mode-locked Fabry-Perot laser with incoherent light produces a mode-locked signal in the following way for use in data transmission. A broadband optical signal is generated from an incoherent light source, such as an LED or a fiber amplifier light source, and then it is spectrum-sliced into different wavelengths through a waveguide grating router (WGR) or an optical filter. Thereafter, each of the spectrum-sliced signals is injected into a corresponding Fabry-Perot laser having no isolator, which outputs a mode-locked signal to be used in transmission. If a spectrum-sliced signal of a predetermined power level or more is injected into the Fabry-Perot laser, the Fabry-Perot laser generates and outputs only the light of a wavelength coincident with the wavelength of the injected signal. The reflective semiconductor optical amplifier (R-SOA) uses the injection of a spectrum-sliced incoherent beam to generate an optical signal for use in transmission. That is, a spectrum-sliced incoherent beam is injected into the reflective semiconductor optical amplifier, which then performs optical amplification and outputs an optical signal to be used in transmission.

However, the DFB laser array and the MFL have a complicated manufacturing process and are high-priced elements. They further require a wavelength stabilization and an accurate wavelength selection of the light source in order to implement the wavelength division multiplexing. Proposed as a spectrum-sliced light source, the LED and SLD are relatively cheap and also have a wide optical bandwidth. However, the LED and SLD are suitable for use as a light source for upstream signals having a lower modulation rate than downstream signals because they have a narrow modulation bandwidth and a low output power.

The Fabry-Perot laser is a low-priced, high-output element, but has disadvantages in that it cannot provide a large number of wavelength-divided channels because of its narrow bandwidth. In addition, it is subjected to serious performance degradation due to the mode partition noise when modulating and transmitting a spectrum-sliced signal at a high rate.

The ultra short pulse light source is coherent and also has a very wide spectrum bandwidth, but its implementation is difficult because the lasing spectrum has a low stability and its pulse width is only several picoseconds.

To replace the above light sources, a spectrum-sliced fiber amplifier light source has been proposed, which can provide a large number of high-power, wavelength-divided channels by spectrum-slicing ASE (Amplified Spontaneous Emission) light generated by an optical fiber amplifier. However, this light source must use an additional high-priced external modulator, such as a LiNbO₃ modulator, for allowing the channels to transmit different data.

The mode-locked Fabry-Perot laser with incoherent light can perform data transmission more economically by directly modulating the Fabry-Perot laser based on a data signal. However, a Fabry-Perot laser used in a low-priced optical transmitter without a temperature controller has a narrow band of available wavelengths due to the changes in the gain wavelength according to the temperature, and the output is thus not uniform according to temperature. In addition, a WDM optical transmission system with the Fabry-Perot laser has a problem in that the system operating costs are high because of the need to use a unique Fabry-Perot laser for each channel.

### SUMMARY OF THE INVENTION

Therefore, the present invention has been made in view of the above problem and provides additional advantages, by providing a WDM optical transmitter capable of operating over a wide range of temperatures as well as enabling channel compatibility.

In accordance with the present invention, there is provided a WDM (Wavelength Division Multiplexing) optical transmitter using a wideband gain laser, comprising a plurality of wideband gain lasers, each laser including a gain medium with a 3 dB bandwidth of 40 nm or more at a threshold current, each laser amplifying corresponding incoherent light injected into the gain medium and outputting a corresponding channel; and a wavelength division multiplexer for multiplexing channels outputted from the wideband gain lasers into an optical signal in a WDM scheme and outputting the multiplexed optical signal.

### BRIEF DESCRIPTION OF THE DRAWINGS

The above features and other advantages of the present invention will be more clearly understood from the following detailed description taken in conjunction with the accompanying drawings, in which:

FIG. 1a shows a WDM optical transmitter using a wideband gain laser according to a preferred embodiment of the present invention;

FIG. 1b shows the configuration of the wideband gain laser shown in FIG. 1a;

FIGS. 2a and 2b show an example of the comparison of the nth wideband gain laser shown in FIG. 1 and a typical Fabry-Perot laser; and

FIGS. 3a to 4b illustrate the operating characteristics of the nth wideband gain laser shown in FIG. 1.

### DETAILED DESCRIPTION

Now, preferred embodiments of the present invention will be described in detail with reference to the annexed drawings. For the purposes of clarity and simplicity, a detailed description of known functions and configurations incorporated herein will be omitted as it may make the subject matter of the present invention unclear.

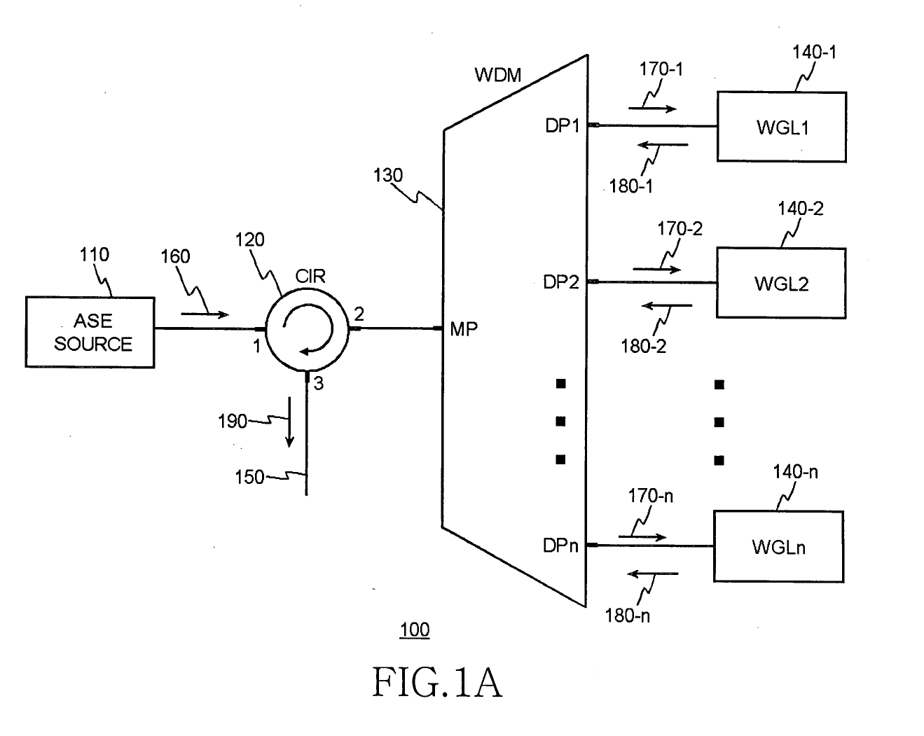

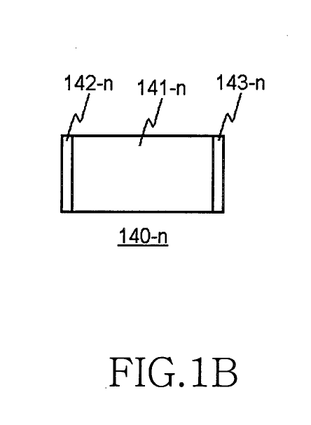

FIG. 1 a shows a WDM optical transmitter having a wideband gain laser according to a preferred embodiment of the present invention, and FIG. 1b shows the configuration of the wideband gain laser shown in FIG. 1a. As shown in FIG. 1a, the optical transmitter 100 includes an ASE (Amplified Spontaneous Emission) source 110, a circulator (CIR) 120, a wavelength division multiplexer (WDM) 130, and 1st to nth wideband gain lasers (WGLs) 140-1˜140-n.

The ASE source 110 outputs incoherent light 160 of a predetermined wavelength band, and it may include an erbium doped fiber amplifier (EDFA) that outputs amplified spontaneous emission. The EDFA may include an erbium doped optical fiber and a pump laser diode for pumping the erbium doped optical fiber.

The circulator 120 includes first to third ports 1201 and 1203. The first port 1201 is connected with the ASE source 10, the second port 1202 is connected with a multiplexing port (MP) of the multiplexer 130, and the third port 1203 is connected with a transmission link 150. The circulator 120 receives the incoherent light 160 through the first port 1201 and outputs it through the second port 1202, and it receives a multiplexed optical signal 190 through the second port 1202 and outputs it through the third port 1203. The circulator 120 is configured so that it outputs light, which it receives through a lower-level port, through a higher-level port near the lower-level port.

The wavelength division multiplexer 130 includes the multiplexing port MP and 1st to nth demultiplexing ports DP1 to DPn. The multiplexing port MP is connected with the second port 1202 of the circulator 120, and the 1st to nth demultiplexing ports DP1 to DPn are connected with the 1st to nth wideband gain lasers 140-1 to 140-n, respectively. The wavelength division multiplexer 130 demultiplexes the incoherent light 160, inputted through the multiplexing port MP, into incoherent beams 170-1 to 170-n according to their wavelengths in a WDM scheme, and then outputs the demultiplexed incoherent beams, respectively, through the demultiplexing ports DP1 to DPn. The multiplexer 130 also multiplexes 1st to nth channels 180-1 to 180-n, received respectively through the 1st to nth demultiplexing ports DP1 to DPn, into an optical signal 190 in a WDM scheme, and outputs the multiplexed optical signal 190 through the multiplexing port MP. The multiplexer 130 may include a waveguide grating router (WGR).

The 1st to nth wideband gain lasers 140-1 to 140-n are connected respectively with the 1st to nth demultiplexing ports DP1 to DPn of the multiplexer 130. The 1st to nth wideband gain lasers 140-1 to 140-n amplify incoherent beams 170-1 to 170-n, which are injected respectively into the lasers 140-1 to 140-n, and output them out to the corresponding channels 180-1 to 180-n. All the 1st to nth wideband gain lasers 140-1 to 140-n have the same configuration. The configuration of the nth wideband gain laser 140-n will now be described hereinafter with reference to FIG. 1b.

Referring to FIG. 1b, the nth wideband gain laser 140-n includes a gain medium 141-n, an anti-reflective layer 142-n, and a highly-reflective layer 143-n. The gain medium 141-n has a wideband gain. The anti-reflective layer 142-n is coated on one end of the gain medium 141-n, facing the nth demultiplexing port DPn, and it has a relatively low reflectance. The highly-reflective layer 143-n is coated on the other end of the gain medium 141-n, and it has a relatively high reflectance. The anti-reflective layer 142-n has a reflectance of 0.01 to 30%, and the highly-reflective layer 143-n has a reflectance of 60 to 100%. Note that a window structure, in addition to the anti-reflective layer 142-n, may be applied to one end of the nth wideband gain laser 140-n to achieve a low reflectance.

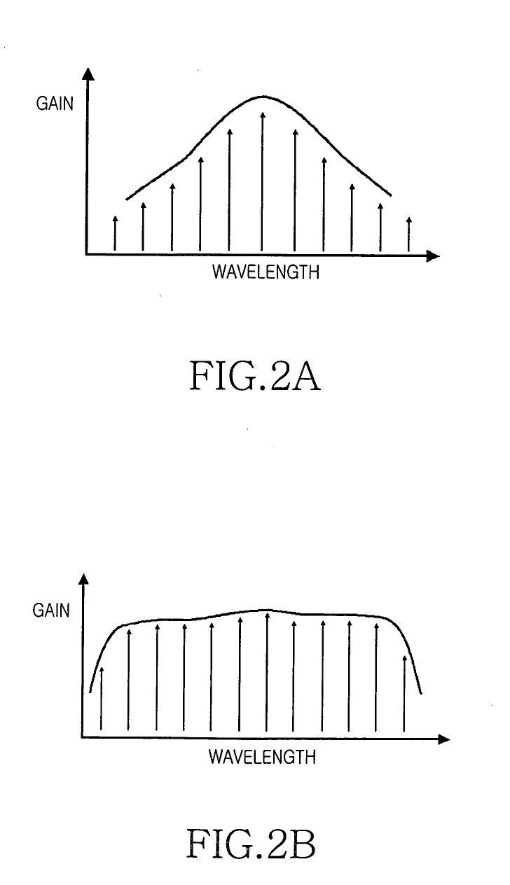

FIGS. 2a and 2b show an example of the comparison of the nth wideband gain laser shown in FIG. 1 and a conventional Fabry-Perot laser. In particular, FIG. 2a shows the gain curve of the conventional Fabry-Perot laser, and FIG. 2b shows the gain curve of the nth wideband gain laser 140-n according to the present invention.

As shown, the gain curve of the conventional Fabry-Perot laser has a peak value at a certain central wavelength, whereas the gain curve of the nth wideband gain laser 140-n according to the teachings of the present invention is flattened over a wide range of wavelengths. Accordingly, the gain curve of the nth wideband gain laser 140-n has an available wavelength bandwidth wider than that of the conventional Fabry-Perot laser and has a 3 dB bandwidth of 40 to 150 nm at a threshold current. With such a gain curve, the nth wideband gain laser 140-n according to the present invention can operate over a wide range of temperatures. The gain curve of the nth wideband gain laser 140-n varies at a rate of about 0.5 nm/° C. as temperature varies, and its output is given by the convolution of the gain curve and a spectrum of the injected incoherent light. When compared to the conventional Fabry-Perot laser, the nth wideband gain laser 140-n is operable over a wider range of temperatures, thus requires no temperature controller. The nth wideband gain laser 140-n can also be used to output a channel other than a predetermined channel as required, so that it provides a favorable channel compatibility during the maintenance and the management of an optical transmitter.

Methods for implementing the nth wideband gain laser 140-n include i) a method for designing an epitaxial structure itself, ii) selective-area growth, and iii) a method for performing differential current injection (for example, varying the amount of currents injected into the gain medium 141-n) depending on the positions (in the longitudinal direction) of the gain medium 141-n.

When the method for designing the epitaxial structure is employed to achieve the wider gain range, a non-uniform (or asymmetric) quantum well structure may be used instead of a uniform (or symmetric) quantum well structure. For the non-uniform quantum well structure, the compositions or the thicknesses of the well/barrier layers may be varied. That is, each well is designed to operate on different transition energy by varying the compositions and/or dimensions of well/barrier layers.

When the selective area growth is employed, a uniform quantum well structure may be used but a mask or the like may be used to gradually vary the gain wavelength according to the areas.

Finally, the method for performing differential current injection depending on the longitudinal positions may be used to achieve a flat gain curve over a wide range of wavelengths in any case where a uniform or non-uniform quantum well structure is used and where the selective-area growth is employed.

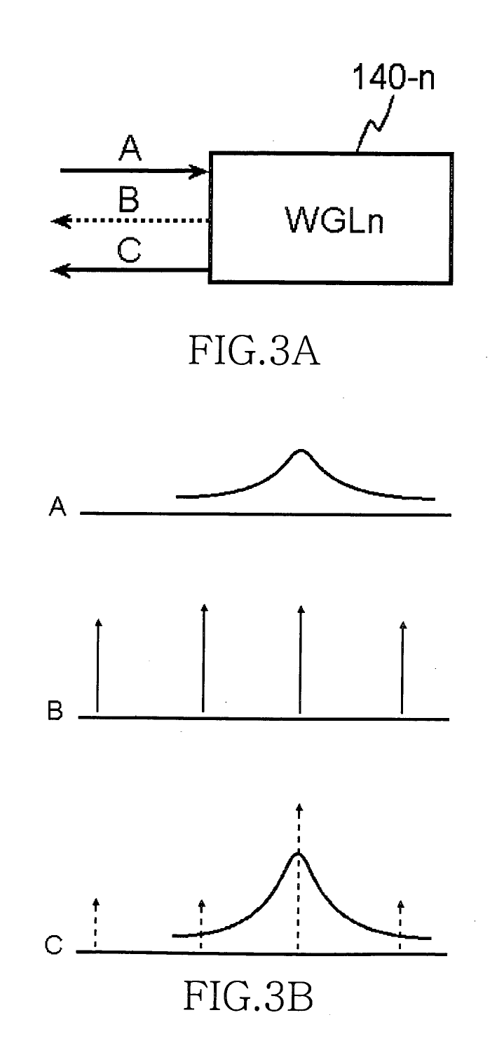

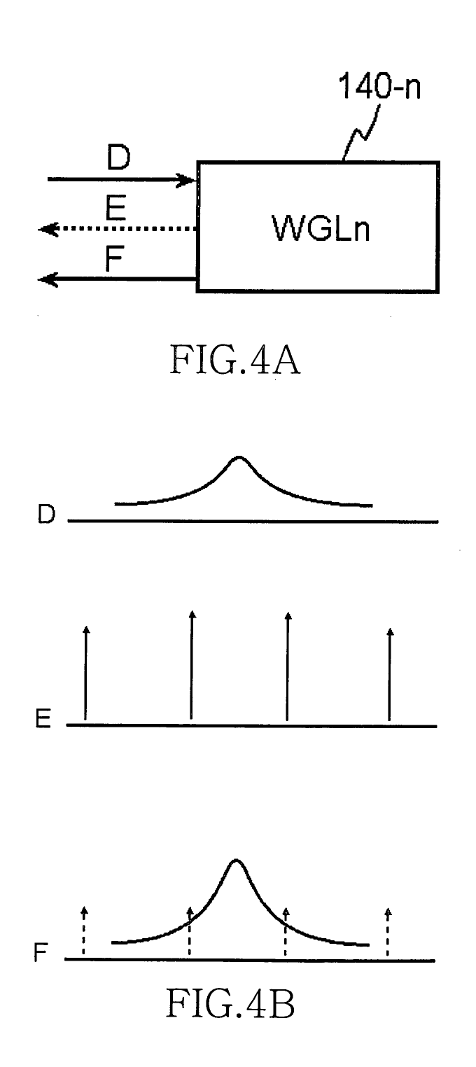

FIGS. 3a to 4b illustrate the operating characteristics of the nth wideband gain laser shown in FIG. 1.

FIGS. 3a and 3b illustrate a multi-path gain phenomenon that occurs in the nth wideband gain laser 140-n. As shown in FIG. 3b, a plurality of lasing modes (B), which are spaced at intervals of a specific wavelength, occur when the nth wideband gain laser 140-n operates at its threshold current or more. The wavelength of injected incoherent light (A) is coincident with that of one of the lasing modes (B), so that a corresponding channel (C) is outputted with the coincident lasing mode being amplified while the other modes are suppressed. This is called a multi-path gain phenomenon, in which the incoherent light (A) obtains a multi-path gain, as the wavelength of the incoherent light (A) satisfies resonance condition in the nth wideband gain laser 140-n.

FIGS. 4a and 4b show a single-path gain phenomenon that occurs in the nth wideband gain laser 140-n. A plurality of lasing modes (E), which are spaced at intervals of a specific wavelength, occur when the nth wideband gain laser operates at the threshold current or more. Since the wavelength of injected incoherent light (D) is not coincident with any one of the lasing modes (E), a channel (F) corresponding to the incoherent light (D) is outputted after obtaining only a single-path gain. This is called a single-path gain phenomenon, in which the incoherent light (D) obtains a single-path gain, as the wavelength of the incoherent light (D) does not satisfy resonance condition in the nth wideband gain laser 140-n.

Referring back to FIG. 1b, the nth wideband gain laser 140-n has the following advantages since it includes the anti-reflective layer 142-n with a low reflectance.

First, since the power of incoherent light reflected from the anti-reflective layer 142-n is low, the efficiency with which injected incoherent light is coupled to the gain medium 141-n is increased, thereby reducing the intensity of incoherent light required for mode-locking. It is thus possible to use a low-priced ASE source.

Second, use of the anti-reflective layer 142-n minimizes the noise caused by incoherent light reflected from the nth wideband gain laser 140-n and also increases the extinction ratio of the nth wideband gain laser 140-n.

Third, when the single-path gain phenomenon occurs instead of the multi-path gain phenomenon, an optical loss at the anti-reflective layer 142-n is reduced, so that amplification efficiency is increased, and it is also possible to maintain transmission characteristics irrespective of the changes in the lasing modes due to temperature changes.

Fourth, the output rate of the anti-reflective layer 142-n, together with the output rate of the highly-reflective layer 143-n, is increased to reduce the optical loss at the highly-reflective layer 143-n. The anti-reflective layer 142-n has a higher reflectance, compared to the anti-reflective layer of a conventional semiconductor optical amplifier. In the semiconductor optical amplifier, it is required for an anti-reflective layer to have a reflectance less than 0.1% in order to suppress lasing in the cavity. A conventional method employed to implement such a semiconductor optical amplifier is to form a tilted waveguide structure, accompanied by a complicated process, and apply an accurate anti-reflective multilayer coating to one end thereof. On the contrary, since it does not need to suppress lasing therein in the present invention, the nth wideband gain laser 140-n has a general waveguide structure, and thus can be easily implemented with a relatively simple anti-reflective coating.

As apparent from the above description, a WDM optical transmitter according to the present invention includes a wideband gain laser employing a gain medium that has a 3 dB bandwidth of 40 nm or more at a threshold current, so that it has a wide range of operable temperatures and channel compatibility.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A WDM (Wavelength Division Multiplexing) optical transmitter comprising:
a plurality of wideband gain lasers, each laser including a gain medium having a 3 dB bandwidth of 40 nm or more at a threshold current, each laser amplifying corresponding incoherent light injected into the gain medium and outputting a corresponding channel; and
a wavelength division multiplexer for multiplexing channels outputted from the wideband gain lasers into an optical signal according to a WDM scheme.

2. The WDM optical transmitter according to claim 1, wherein each of the wideband gain lasers further includes:
an anti-reflective layer coated on one end of the gain medium, through which the corresponding incoherent light is injected into the gain medium; and
a highly-reflective layer coated on the other end of the gain medium.

3. The WDM optical transmitter according to claim 2, wherein said anti-reflective layer having a relatively low reflectance.

4. The WDM optical transmitter according to claim 2, wherein said highly-reflective layer having a relatively high reflectance.

5. The WDM optical transmitter according to claim 1, wherein the gain medium has a 3 dB bandwidth of 40 to 150 nm at the threshold current.

6. The WDM optical transmitter according to claim 2, wherein the anti-reflective layer has a reflectance of 0.01 to 30%.

7. The WDM optical transmitter according to claim 2, wherein the highly-reflective layer has a reflectance of 60 to 100%.

8. The WDM optical transmitter according to claim 1, wherein the wavelength division multiplexer includes a waveguide grating router.

9. The WDM optical transmitter according to claim 1, further comprising:
an ASE (Amplified Spontaneous Emission) source for outputting the incoherent light of a predetermined wavelength band; and
a circulator for outputting the incoherent light received from the ASE source to the multiplexer and for transmitting an optical signal received from the multiplexer to an optical transmission link coupled with the circulator,
said multiplexer demultiplexing incoherent light received from the circulator into beams according to their wavelengths and outputting the demultiplexed beams to the wideband gain lasers.

10. The WDM optical transmitter according to claim 9, wherein the ASE source comprises an erbium doped fiber amplifier (EDFA).

11. The WDM optical transmitter according to claim 1, wherein the plurality of the wideband gain lasers is made of an non-uniform quantum well structure configured to operate on a different transition energy by varying the compositions and/or dimensions of the well structure.

12. The WDM optical transmitter according to claim 1, wherein the plurality of the wideband gain lasers is produced using a selective-area growth method via a mask, and an amount of currents injected into the gain medium is selectively controlled on the longitudinal positions of the gain medium.

13. The WDM optical transmitter according to claim 1, wherein the plurality of the wideband gain lasers is produced by performing differential current injections on the longitudinal positions of the gain medium, and an amount of currents injected into the gain medium is selectively controlled on the longitudinal positions of the gain medium to achieve a wide gain curve.
